(19) United States
(12) Patent Application Publication
(10) Pub. No.: US 2015/0289310 A1
(43) Pub. Date: Oct. 8, 2015

(54) CELLULAR BASE STATION

(71) Applicant: HEWLETT-PACKARD DEVELOPMENT COMPANY, L.P., Houston, TX (US)

(72) Inventor: Deepak Bhatia, Singapore (SG)

(73) Assignee: HEWLETT-PACKARD DEVELOPMENT COMPANY, L.P., Houston, TX (US)

(21) Appl. No.: 14/437,024

(22) PCT Filed: Nov. 5, 2012
(86) PCT No.: PCT/US2012/063523

§ 371 Date: Apr. 20, 2015

(51) Int. Cl. H04W 76/02

(52) U.S. Cl. CPC H04W 76/025; H04W 88/06

(57) ABSTRACT

Examples disclosed hereto relate to a computing device for providing cellular network access to a plurality of mobile devices. The computing device includes a wireless wide area network (WWAN) card. The WWAN card includes a controller to enable the WWAN card as a base station. A local area network (LAN) interface is provided to establish connection to a cellular backhaul network. The LAN interface is communicatively coupled to a LAN and to the WWAN card. The LAN is communicatively coupled to the cellular backhaul network.

### BACKGROUND

Mobile devices such as smartphones have become increasingly popular. Mobile devices rely on base stations for network access. Each base station has a coverage area for servicing mobile devices connected thereto. For example, a base station may have a large coverage area spanning several miles, or a small coverage area. Due to the mobility of users, mobile devices are constantly connecting to different base stations as users move from one coverage area to another.

### BRIEF DESCRIPTION OF THE DRAWINGS

The following detailed description references the drawings, wherein:

FIG. 1 is a block diagram of a computing device including a wireless wide area network (WWAN) card enabled as a base station for providing cellular network access, according to one example;

FIG, 2 is a block diagram of a computing device including a WWAN card enabled as a base station for providing cellular network access, according to one example;

FIG. 3 is a flowchart of a method for enabling a WWAN card of a computing device as a base station for providing cellular network access, according to one example;

FIG. 4 is a flowchart of a method for enabling a plurality of WWAN cards as a network of base stations for providing cellular network access, according to one example; and

FIG. 5 is a WWAN controller including a machine-readable storage medium encoded with instructions for enabling a WWAN card as a base station for providing cellular network access, according to one example.

### DETAILED DESCRIPTION

Cellular network services (e.g., voice and data) are generally provided by base stations capable of servicing a wide area (e.g., a macrocell). Base stations are installed by network providers to provide communication services to subscribers. However, coverage within buildings (e.g., home, office) and dense environments is generally more challenging due to issues with wireless signal propagation caused by the building structure and surrounding buildings. For example, shadowing effects, multipath fading, and interferences make it difficult to provide coverage within building structures and in dense environments.

Conventional solutions to the above problems include deploying small cells such as femtocells, picocells, microcells, and attocells. For example, femtocells may be deployed in a home, small business, office buildings, or other limited coverage areas, to improve cellular coverage for data and voice. However, this solution often requires multiple femto/pico base stations to be set up to provide coverage is such areas. For example, multiple base stations may be set up on a building floor to provider coverage to the mobile devices requiring coverage (e.g., subscribers). Each base station requires cumbersome cabling (e.g., broadband internet connection to provide connection to the network backhaul) to set up and may also be time consuming. Thus, this solution may become increasingly expensive and inefficient as additional base stations are added.

Accordingly, various examples disclosed here relate to improving cellular coverage in buildings (e.g., home and office environments) and dense enterprises by using wireless wide area network (WWAN) cards embedded in computing devices (e.g., laptops). The described examples reduce setup time and cost of implementing a cellular base station in areas where cellular coverage is needed, by enabling the WWAN card embedded in a portable personal computing device. The WWAN card may be disabled from functioning as a base station. For example, the WWAN card may be switched to a client mode for normal client-type operation, The WWAN card includes a controller (e.g., firmware/hardware) for implementing cellular communication protocols when the WWAN card is enabled as a base station.

In one example, a computing device for providing cellular coverage includes a WWAN comprising a controller (e.g., a WWAN controller) to enable the WWAN card as a base station. The WWAN card, when enabled as a base station provides cellular network access to a plurality of mobile devices. The computing device also includes a local area network (LAN) interface to establish connection to a cellular backhaul network. The LAN interface (e.g., an Ethernet port or a Wi-Fi interface) is communicatively coupled to a LAN (e.g., Internet) and to the WWAN card. The LAN is communicatively coupled (e.g., wired) to the cellular backhaul network.

In one example, a method for providing cellular coverage includes enabling a WWAN card of a computing device as a base station for providing cellular network access to a plurality of mobile devices. The method also includes receiving cellular signals (e.g., voice and data) at the WWAN card from a cellular backhaul network via a LAN. The WWAN card is communicatively coupled to the LAN via a LAN interface of the computing device and the LAN is communicatively coupled to the cellular backhaul network. The method includes transmitting the cellular signals to the plurality of mobile devices via the WWAN card.

In one example, a non-transitory computer-readable medium includes instructions that, when executed by a WWAN controller of a computing device, cause the WWAN controller to enable a WWAN card as a base station to provide a plurality of mobile devices with cellular network access. The instructions further cause the WWAN controller to route cellular network traffic between a cellular network provider and the plurality of mobile devices via the WWAN card using cellular communication protocols. The WWAN card is communicatively coupled to a cellular set work provider via a LAN interface, where the LAN interface is communicatively coupled to a LAN.

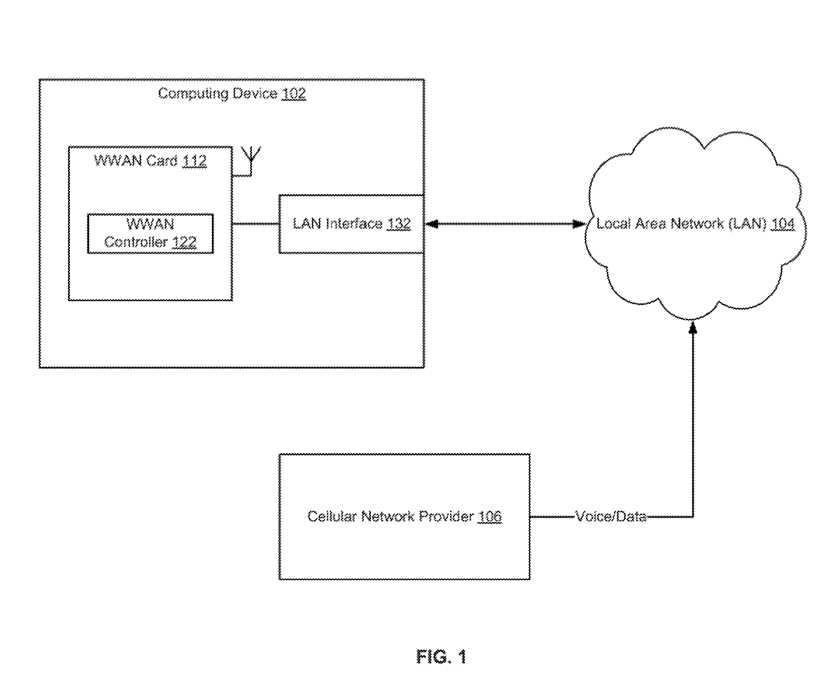

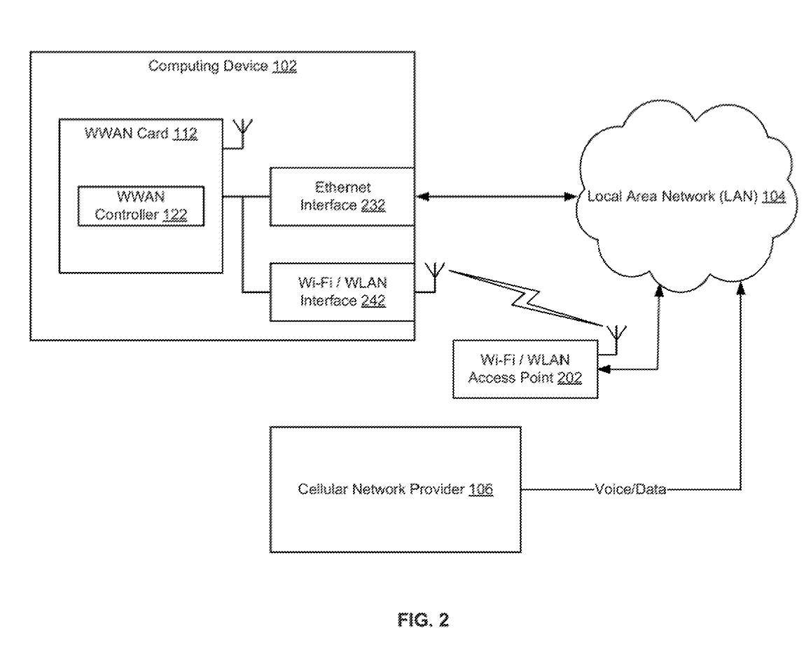

FIG. 1 is a block diagram of a computing device including a WWAN card enabled as a base station for providing cellular network access, according to one example. Computing device 102 includes a WWAN card 112 communicatively coupled to a LAN interface 132. Computing device 102 is coupled to a LAN 104 (e.g., an office/enterprise network or the Internet) via the LAN interface 132. In certain examples, the LAN interface 132 is a wired interface such as an Ethernet, port/interface. In other examples, the LAN interface 132 is a wireless interface such as a Wi-Fi interface or other wireless LAN interfaces. The LAN 104 is coupled to a cellular network provider's network 106. In one example, the LAN 104 is linked to the cellular network provider 106 via a wired connection.

The cellular network may include a long term evolution (LTE) network, a code division multiple access (CDMA) network, a global system for mobile communications (GSM) network, a universal mobile telecommunications system, (UMTS) network, or a worldwide interoperability for microwave access (WiMAX) network. The cellar network provider 106 may provide voice and data services to a plurality of subscribers,

WWAN card 112 includes a WWAN controller 122. Controller 122 may include a combination of hardware and software/firmware for controlling the operation of the WWAN card 112. For example, controller 122 may include firmware and device driver for enabling the WWAN card 112 to function as a base station. Controller 122 may also enable the WWAN card 112 to function in a normal mode (e.g., as a client device), where the WWAN card 112 can connect and transmit data over a wide area network (e.g., surf the web, check emails).

Controller 122 may also implement cellular communication protocols to enable the WWAN card 112 function as a cellular base station to offer wireless cellular network connectivity to surrounding mobile devices in the area of interest (e.g., as office space). Accordingly, controller 122 is configured to switch the WWAN card 112 of a computing device 102 between a base station operation mode and a normal client operation mode, as desired. Controller 122 may be configured to change a coverage area/range of the WWAN card 112 by changing a transmit power level of the WWAN card 132. For example, the transmit power level may be increased to increase a coverage area of the WWAN card 112, or the transmit power level may be decreased to reduce the coverage area of the WWAN card 112.

Thus, when the WWAN card 112 is enabled as a base station, voice and data services from the network provider 106 is routed via wired infrastructure to the LAN 104 (e.g., a. local office network) and finally to the computing device 102 that acts as a base station to provide wireless connectivity to surrounding mobile devices within a coverage area (an office space). Depending on the need for additional base stations (e.g., more coverage area, more users/mobile devices to service), additional computing devices 102 may be enabled to provide the additional base stations. Accordingly, the described examples provide a technique for providing base stations where cellular coverage is desired, at a reduced set up time and cost, by enabling a WWAN card 112 embedded in a computing device 102.

FIG. 2 is a block diagram of a computing device including a WWAN card enabled as a base station for providing cellular network access, according to one example. Computing device 102 includes WWAN card 112 coupled to an Ethernet interface 232 and to a Wi-Fi/WLAN interface 242. Computing device 102 is coupled to a LAN 104, and LAN 104 is coupled to a cellular network provider 106. Wi-Fi/WLAN Interface 242 is communicatively coupled to a Wi-Fi/WLAN access point 202, and the Wi-Fi/WLAN access point 202 is coupled to the LAN 104.

In the example of FIG. 2, LAN interface 132 of FIG. 1 may be at least one of an Ethernet interface 232 and a Wi-Fi/WLAN interface 242 for establishing connection to the LAN 104. Accordingly, backhaul connectivity to the cellular network provider (e.g., via internet or broadband access) can be procured using a Wi-Fi link that connects to an access point. For example, Wi-Fi interface 242 provides an alternate route (e.g., in addition to the wired Ethernet interface 232) to the cellular network provider 106 via Wi-Fi access point 242 that provides internet/broadband access to the computing device 102. This enables computing device 102 to be a portable mobile base station (e.g., a reverse hotspot).

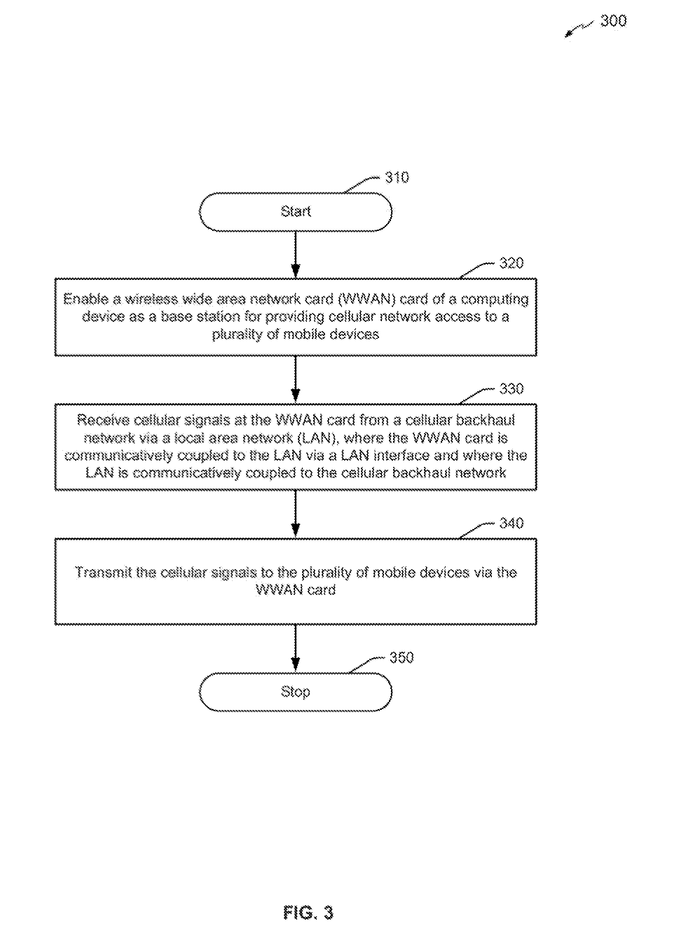

FIG. 3 is a flowchart of a method 300 for enabling a WWAN card of a computing device as a base station for providing cellular network access, according to one example. Although execution of method 300 is described below with reference to controller 122, other suitable components for execution of method 300 can be utilised. In addition, the components for executing the method 300 may be spread among multiple devices. Method 300 may be implemented in the form of executable instructions stored on one or more non-transitory machine-readable storage media and/or in the form of electronic circuitry.

Method 300 may start in block 310 and proceed to block 320, where a WWAN card of a computing device is enabled as a base station for providing cellular network access to a plurality of mobile devices. For example, WWAN card 112 includes controller 122, where controller 122 is configured to enable WWAN card 112 as a base station. In certain examples, controller 122 switches WWAN card 112 from a client device operation mode to a base station operation mode. In the base station operation mode, controller 122 implements cellular communication protocols for communicating with the plurality of mobile devices and for providing voice and data services to the plurality of mobile devices.

Method 300 may proceed to block 330, where cellular signals are received at the WWAN card from a cellular backhaul network via a LAN. For example, WWAN card 112 is configured by controller 122 to receive cellular signals (e.g., voice and data signals) from cellular network provider 106 through LAN 104. WWAN card 112 is coupled to a LAN interface 132 (e.g., Ethernet interface 232 or Wi-Fi-WLAN interface 242) for connection to a LAN 104 (e.g., an office or building local network). LAN 104 is wired to the cellular network provider 106 (e.g., via fiber optics).

Method 300 may proceed to block 340, where the cellular signals are transmitted to the plurality of mobile devices via the WWAN card. For example, the cellular signals are received at the WWAN card 112, processed (e.g., destination devices are determined), and transmitted to the plurality of mobile devices using cellular communication protocols. Method 300 may then proceed to block 350, where the method 300 stops.

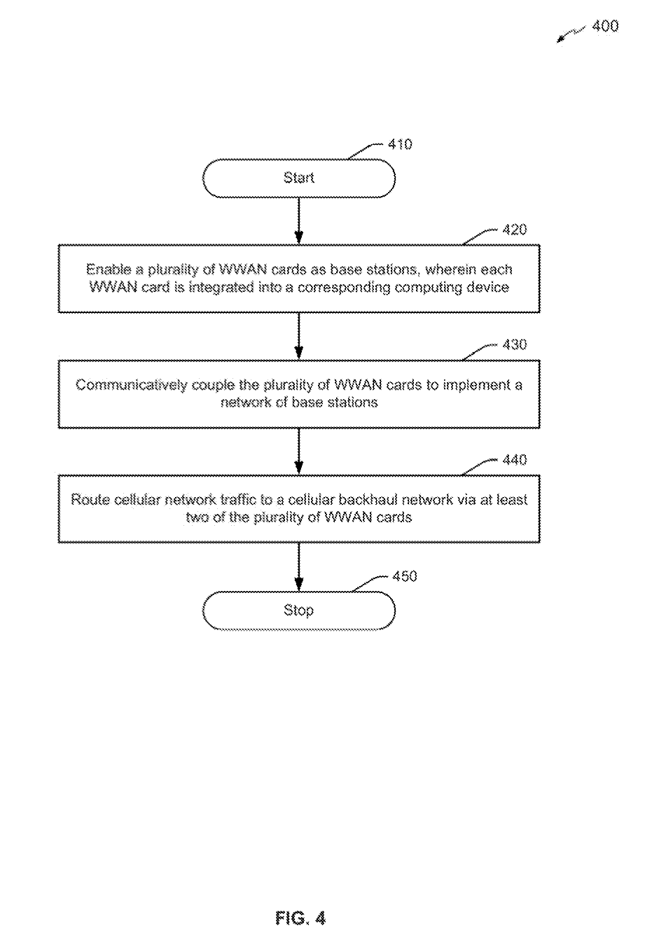

FIG. 4 is a flowchart of a method 400 for enabling a plurality of WWAN cards as a network of base stations for providing cellular network access, according to one example. Although execution of method 400 is described below with reference to controller 122, other suitable components for execution of method 400 can be utilised. In addition, the components for executing the method 400 may be spread among multiple devices. Method 400 may be implemented in the form of executable instructions stored on one or more non-transitory machine-readable storage media and/or in the form of electronic circuitry.

Method 400 may start in block 410 and proceed to block 420, where a plurality of WWAN cards are enabled as base stations. Each WWAN card is integrated into a corresponding computing device. For example, multiple WWAN cords 112 may be enabled in multiple computing devices 102 such that multiple base stations are implemented.

Method 400 may proceed to block 430, where the plurality of WWAN cards are communicatively coupled to implement a network of base stations. For example, a particular WWAN card 112 may be connected to other WWAN cards 112 in the network. Thus, the WWAN card 112 may know the location and the identity of the other WWAN cards 112 for data and voice routing purposes, for example. Accordingly, a mesh network of WWAN cards 112 may be implemented.

Method 400 may proceed to block 440, where cellular network traffic is routed to a cellular backhaul network via at least two of the plurality of WWAN cards. For example, voice and data services for a plurality of mobile devices may be routed via two of more of the WWAN cards 112 of the network of WWAN cards 112 (e.g., network of base stations). Depending on the seed for additional base stations (e.g., increased coverage area), additional WWAN cards 112 (additional computing devices 102) can be enabled to provide additional base stations. For example, it may be desirable to enable additional WWAN cards 112 as base stations when one or more base station laptop users leave the office, or when more users are added to the office space covered by existing base stations. The method 400 may then proceed to block 450, where the method 400 stops.

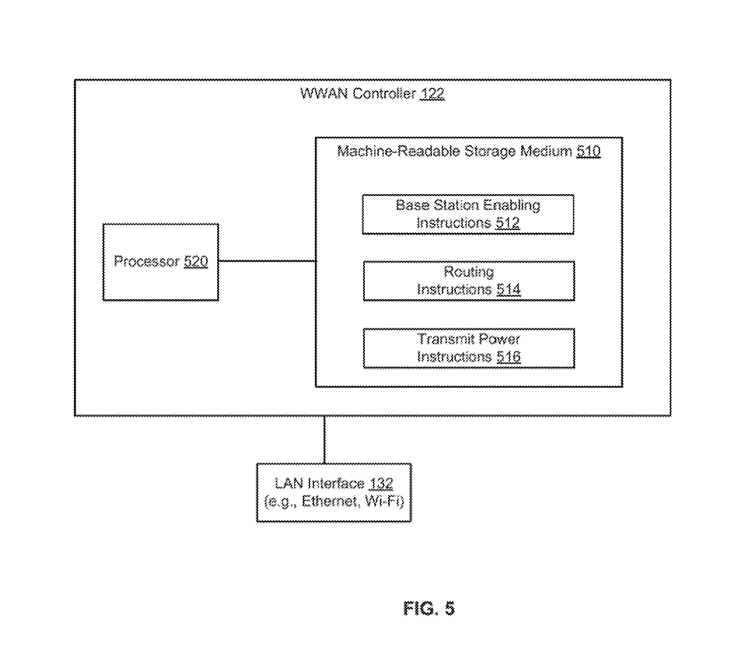

FIG. 5 is a block diagram of a WWAN controller including a machine-readable storage medium encoded with instructions for enabling a WWAN card as a base station for providing cellular network access, according to one example. WWAN controller 122 includes, for example, a processor 520 and a machine-readable storage medium 510 including instructions 512, 514, and 516 for enabling a WWAN card 112 as a base station for providing cellular network access to a plurality of mobile devices. WWAN controller 122 may be communicatively coupled to LAN interface 132, where LAN interface 132 includes an Ethernet interface/port or a Wi-Fi/WLAN interface.

Processor 520 may be a microprocessor, a semiconductor-based microprocessor, other hardware devices or processing elements suitable for retrieval and execution of instructions stored in machine-readable storage medium 510, or any combination thereof. Processor 520 may fetch, decode, and execute instructions stored in machine-readable storage medium 510 to implement the functionality described in detail below. As an alternative or in addition to retrieving and executing instructions, processor 520 may include at least one integrated circuit (IC), other control logic, other electronic circuits, or any combination thereof that include a number of electronic components for performing the functionality of instructions 512, 514, and 516 stored in machine-readable storage medium 510. Further, processor 520 may include single or multiple cores in a chip, include multiple cores across multiple devices, or any combination thereof.

Machine-readable storage medium 510 may be any non-transitory electronic, magnetic, optical, or other physical storage device that contains or stores executable instructions. Thus, machine-readable storage medium 510 may be, for example, FLASH memory. Read Only Memory (ROM), Random Access Memory (RAM), an Electrically Erasable Programmable Read-Only Memory (EEPROM), a storage drive, a Compact Disc Read Only Memory (CD-ROM), and the like. Further, machine-readable storage medium 510 can be computer-readable as well as non-transitory. As described in detail below, machine-readable storage medium 510 may be encoded with a series of executable instructions for enabling a WWAN card as a base station for cellular connectivity. Other suitable formats of the executable instructions will be apparent to those of skill in the art.

Machine-readable storage medium 510 may include base station enabling instructions 512, which may be configured to enable WWAN card 112 as a base station to provide a plurality of mobile devices with cellular network access. For example, WWAN card 112 may be enabled as a base station to provide voice and data services to the plurality of mobile devices.

Machine-readable storage medium 510 may include routing instructions 514, which may be configured to route cellular network traffic between a cellular network provider and the plurality of mobile devices via the WWAN card using cellular communication protocols. For example, WWAN card 112 may be configured to implement cellular communication protocols for receiving and/or transmitting cellular signals between the cellular network provider 106 and the plurality of mobile devices.

Machine-readable storage medium 510 may include transmit power instructions 516, which may be configured to determine a transmit power level of the WWAN card that corresponds to a coverage area of the WWAN card, and to transmit cellular signals to the plurality of mobile devices at the transmit power level. For example, the transmit power level of the WWAN card 112 may be set such that the transmit power level corresponds to a desired coverage area of the WWAN card 112. In addition, the transmit power level may be set such that the WWAN card 112 does not interfere with neighboring base stations or encroach on licensed frequencies.

What is claimed is:

1. A computing device for providing cellular coverage, comprising:
a wireless wide area network (WWAN) card comprising a controller to enable the WWAN card as a base station to provide a plurality of mobile devices with cellular network access; and
a local area network (LAN) interface to establish a connection to a cellular backhaul network, wherein the LAN interface is communicatively coupled to a LAN and to the WWAN card, and wherein the LAN is communicatively coupled to the cellular backhaul network.

2. The computing device of claim 1, the controller to implement cellular communication protocols for communicating with the plurality of wireless devices.

3. The computing device of claim 1, wherein the WWAN card is communicatively coupled to the cellular backhaul network via the LAN interface.

4. The computing device of claim 1, wherein the LAN interface comprises at least one of an Ethernet interface and a Wi-Fi interface.

5. The computing device of claim 1, the WWAN card to:
transmit voice and data communications from the cellular backhaul network to the plurality of mobile devices; and
transmit voice and data communications from the plurality of mobile devices to the cellular backhaul network.

6. The computing device of claim 1, the controller to enable the WWAN card as a client device, wherein the WWAN card does not provide cellular communication services to the plurality of mobile devices when enabled as the client device.

7. The computing device of claim 1, the controller to set a transmit power level of the WWAN card, wherein the transmit power level corresponds to a predetermined coverage area of the WWAN card.

8. The computing device of claim 1, wherein the cellular backhaul network comprises at least one of a long term evolution (LTE) network, code division multiple access (CDMA) network, global system for mobile communications (GSM) network, universal mobile telecommunications system. (UMTS) network, and a worldwide interoperability for microwave access (WiMAX) network.

9. The computing device of claim 1, wherein the computing device comprises at least one of a laptop computer, a portable personal computer, a tablet computer, a desktop computer, a multimedia player, an entertainment unit, a data communication device, and a portable reading device configured with a WWAN card.

10. A method for providing cellular coverage, comprising:
enabling a wireless wide area network (WWAN) card of a computing device as a base station for providing cellular network access to a plurality of mobile devices;
receiving cellular signals at the WWAN card from a cellular backhaul network via a local area network (LAN), wherein the WWAN card is communicatively coupled to the LAN via a LAN interface of the computing device and wherein the LAN is communicatively coupled to the cellular backhaul network; and
transmitting the cellular signals to the plurality of mobile devices via the WWAN card.

11. The method of claim 10, wherein the LAN interface comprises at least one of an Ethernet interface and a Wi-Fi interface.

12. The method of claim 11, wherein the Wi-Fi interface is communicatively coupled to a Wi-Fi access point and wherein the Wi-Fi access point is communicatively coupled to the LAN.

13. The method of claim 10, comprising;
enabling a plurality of WWAN cards as base stations, wherein each WWAN card is integrated into a corresponding computing device;
communicatively coupling the plurality of WWAN cards to implement a network of base stations;
routing cellular network traffic to the cellular backhaul network via at least two of the plurality of WWAN cards.

14. A non-transitory computer-readable medium comprising Instructions that, when executed by a wireless wide area network (WWAN) controller of a computing device, cause the WWAN controller to:
enable a WWAN card as a base station to provide a plurality of mobile devices with cellular network access;
route cellular network traffic between a cellular network provider and the plurality of mobile devices via the WWAN card using cellular communication protocols, wherein the WWAN card is communicatively coupled to a cellular network provider via a local area network (LAN) interface, and wherein the LAN interface is communicatively coupled to a LAN.

15. The non-transitory computer-readable medium of claim 14, further comprising instructions to:
determine a transmit power level of the WWAN card that corresponds to a coverage area of the WWAN card; and
transmit cellular signals to the plurality of mobile devices at the transmit power level.
